(19) United States
(12) Patent Application Publication
(10) Pub. No.: US 2006/0294375 A1
(43) Pub. Date: Dec. 28, 2006

(54) System for the assets identification and protection

(76) Inventor: Jaroslav Repta, Trebic (CZ)

Correspondence Address: Larry L. Coats;Coats & Bennett, 1400 Crescent Green, Ste. 300, Cary, NC, 27511, US

(21) Appl. No.: 10/580,925

(22) PCT Filed: Nov. 26, 2004
(86) PCT No.: PCT/CZ04/00080

§ 371 Date: May 30, 2006

(30) Foreign Application Priority Data
Nov. 28, 2003 (CZ) PUV 2003-14833

(51) Int. Cl. H04L 9/00

(52) U.S. Cl. 713/168

(57) ABSTRACT

System of the assets identification Ond protection which is bound to marking Ond reverse identification of stolen things or lost transport means, things and animals by the means of electronic records, in order to determinate correctly the origin and the owner. It consists of protection elements (microdots and microchips bearing unique codes), registered in the database of protected property of the central register, which is connected to the terminals of authorized persons (clients with the access to the central register via Internet) and of the protection elements database of the central register, which is connected to the set of registered terminals places. Each terminal, in the set of terminals of authorized persons, is equipped by the readers of protection elements. Each terminal in the set of registration places is equipped by applicators of the protection elements. All protection elements, used in the identification sets and placed on registered protected property, are registered in the central register of the system for the assets identification and protection.

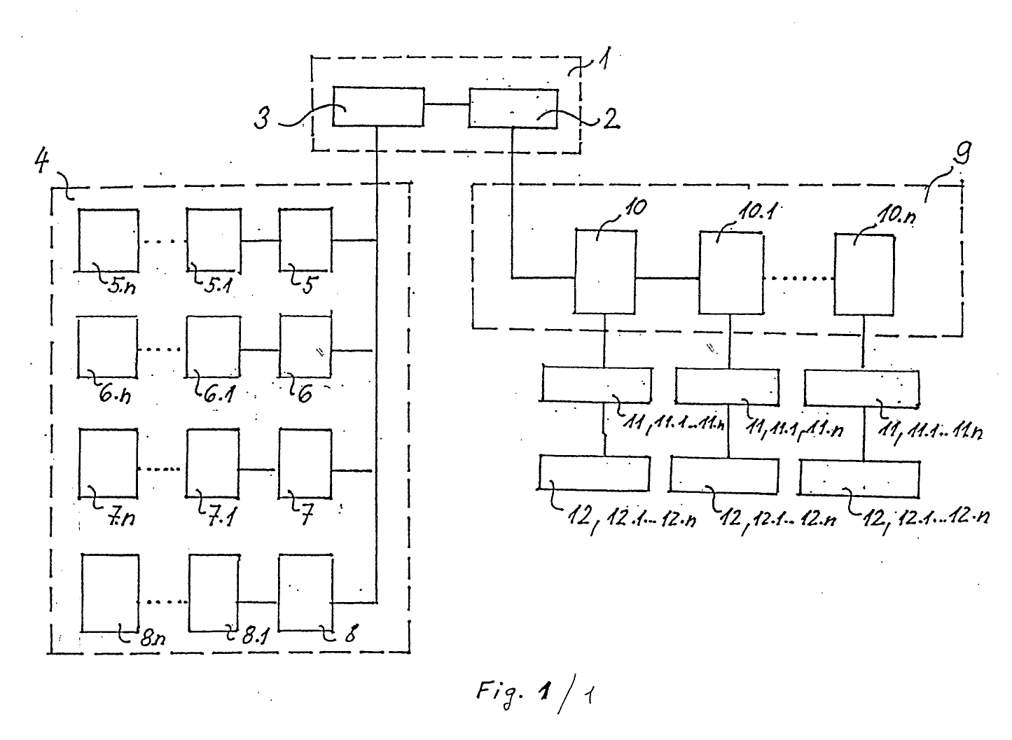

### TECHNICAL FIELD

The technological design applies to the system for the assets identification and protection, which is namely intended for the identification and re-identification of stolen or lost vehicles, objects and animals by means of the electronic records in order to trace their origin and their authorized owner precisely.

### BACKGROUND ART

Currently, there is a number of security systems and equipment for buildings, means of transportation and/or objects available. Their purpose is to search them in case they have been stolen or to protect these objects against a theft. Although this equipment exists we cannot expect that, by means of them, a thievery of vehicles or objects can be totally prevented. Regarding the fact that, despite their continuous development, the effect of these devices is overcome again and again. The frequency of the cases of stolen assets is still very high. Also the re-identification or tracing the origin of the stolen assets, in case they are secured or found, may be a problem one cannot overlook; namely in the case of a disassembly of vehicles or objects to individual parts can be a problem, which can be almost unsolvable in many cases and the evidencing procedure, related to the identification of the authorized owner of these stolen assets, tends to be very lengthy and unsuccessful in many cases.

The purpose of the technological solution is to create such an identification and protection system, which would enable relatively simple and secure identification of vehicles, objects and animals with their precise recording. The placing of identification elements would be also possible on individual parts or other suitable spots of vehicles, objects and animals with high frequency and density of identified spots.

### DISCLOSURE OF THE INVENTION

To a great extent the shortcomings specified above are removed by the system for the identification and protection of assets, which also meets the purpose of technological solution. It consists of a set of protection elements (microdots and microchips bearing unique codes) registered in the computer database of the central register of protected assets, which is linked to the set of terminals of authorized persons (clients with the access to the central register via Internet) and the database of protection elements of the central register, connected to the set of terminals of registration places (authorized workshops and clients who mark and register protected things by themselves) under the technical solution, which is based on a principle that the protection elements from the protection elements set consist of the encapsulated microchips (electronic devices with an unique code which is read by the reader of microchips) and/or of identification microdots (small particles bearing an unique laser-made code, read by the reader of microdots), which are provided with the identification data and the required number of protection elements (1-5 microchips and 10-25 microdots) from the protection elements set, assigned to one owner, is placed on the protected assets in the registration places, which consists of protection elements applicators (spraying guns, brushes, sprays), linked to the database of protection elements in the central register and the central register is linked to the set of terminals of authorized persons which are created by Police terminals, insurance companies terminals as well as the terminals of other authorized persons and those of users. Individual terminals, in the set of terminals of authorized persons, are provided with the readers of protection elements from protection elements set and individual terminals in the registration places set are provided with the application equipment of the protection elements from the protection elements set. The protection elements consist of microchips and microdots.

All protection elements, placed on the protected things and used in the identification sets, are registered in the central register. The central register contains a database of protection elements used in the identification sets, a database of protection elements placed on protected things, a database of protected things and a list of stolen things. The central register enables various levels of accesses into the database, from the administrator and Police to other authorized users. It secures the protection of personal data of persons using the system for the assets identification and protection.

The whole system for the assets identification and protection is internally connected among the protection elements, protected things, their owners, who can communicate with the database via Internet, mainly because of checking of stolen things

The advantages, according to the technical solution, are as follow. It is possible to mark the transport means, things and animals efficiently because of the protection elements may be placed anywhere in high quantity and fixed firmly to nearly any surface without destroying of their characteristics or structure.

It is practically impossible to remove all protection elements. They are very small and hard to be removed. But the only one found protection element is enough for the identification when it is compared with the database.

Each of the protection elements bears an unique information (unique codes of microdots and microchips), which is stored in a database of the central register with all data about the protected assets. That data may be read by the readers and checked in the central register, if necessary, by the authorized persons.

The technology of the protection elements production (microdots and microchips) fulfils all requirements resistance against a moisture, high and low temperature, shakes or other influences. It secures a high reliability of the system. The authorized persons may not only find out the origin and the owner of the registered property but they can also check the data when the property is destroyed.

As for animals, the protection elements must be placed at the veterinary or at the animal shelters by the hygienically packed applicators.

### BRIEF DESCRIPTION OF THE DRAWING

In the attached drawing, the basic building elements of the system, according to the technical design and their mutual interconnection in the block schematic design can be seen.

### RELATION SIGNS

1—central register
2—database of protection elements
3—database of protected assets
4—set of terminals of authorized persons
5, 5.1 . . . 5.n—Police terminals
6, 6.1 . . . 6.n—insurance companies terminals
7, 7.1 . . . 7.n—other authorized persons terminals
8, 8.1 . . . 8.n—users terminals
9—set of terminals of registration places
10, 10.1 . . . 10.n—registration places terminals
11,11.1, . . . 11.n—set of protection elements
12, 2.1 . . . 12.n—protected assets

### EXAMPLES OF THE PATENT CONCEPTS

1. Example: Protection elements (microdots and microchips) are sprayed and glued on the protected things (vehicles, motorcycles, building machines, caravans, boats etc.) on many hidden and visible places. The data about the protected things and the owners is recorded into central register. In case of stealing such things and when they are found, the codes from the protection elements may be read by a readers and checked via Internet in the central register. The found things are possible to be identified unambiguously and returned to the owners.

2. Example: Protection elements (microdots and microchips) are applied by a brush and glued on the protected things (electronics, PCs, printers, antiques, artworks, tools, spare parts, etc.) on many hidden and visible places. The data about the protected things and the owners is recorded into central register. The data stored in the central register serves for future usage in case of thievery.

3. Example: Protection elements (microdots and microchips) are sprayed or applied by a brush and glued on the protected things on many hidden and visible places. The data about the protected things and the owners is recorded into central register. Those things, in case of renting them or selling them, are easy to be identified when the codes are read by readers. That is why it is possible to check if the same things, which were rented, were returned or if the complaints are rightful when some malfunctions occur with sold things.

4. Example: Protection elements (microdots and microchips) are applied on animals by the hygienically safe way. Microchips are implanted at the veterinary clinics. Microdots are applied on animals by a brush on shell, mail, legs, pecker, wings, skin etc.

5. Example: Protection elements (microdots and microchips) are applied on various printed matters, forms, packages, books, semi-finished products, finished products, etc. The data stored in the central register serves for the identification of their flows (forms among offices, packages between a production and shipping, books in libraries, semi-finished production in the production process, finished products on the way to customers etc.)

### INDUSTRIAL UTILIZATION OF THE INVENTION

It is possible to make use of the invention as shown on the picture of the central register 1 including a database 2 of protection elements and the database 3 of the protected assets. Further, by means of the database 3 of the protected assets, the central register 1 is linked to the set of 4 terminals of authorized persons, consisting of 5, 5.1 . . . 5n terminals of police, terminals 6, 6.1 . . . 6.n of insurance companies, terminals 7, 7.1 . . . 7.n of other authorized persons and terminals 8, 8.1 . . . 8.n of users and further by means of the database 2 of protection elements of the central register 1 is linked to the set 9 of registration places, which consist of protection elements applicators 10, 10.1 . . . 10.n, which, using the required number of protection elements from the set of protection elements 11.11.1, . . . 11.n, identify the protected assets 12, 12.1 . . . 12.n.

The system under the technological solution operates in such a way that the applicators 10, 10.1 . . . 10a of protected elements apply them, in the set 9 of registration places, by means of the application equipment, which is, able to integrate the required, number of protection elements on the protected assets 12, 12.1 . . . 12.n, while the protected elements bear the information, which, in connection with the database 2 of protected elements and the database 3 of the protected assets, assigns the unique and original data to the protected assets 12, 12.1 . . . 12.n. Consequently, the set of authorized persons 4 can re-identify the protected assets 12, 12.1 . . . 12.n as required and in this way to ensure further procedure with its finding, return or liquidation.

1-3. (canceled)

4. A system for identifying and protecting assets, the system comprising:
a central register comprising:
an assets database configured to store registered assets; and
a protection elements database operatively connected to the assets database and configured to store a plurality of protection elements, wherein said protection elements comprise at least one of an encapsulated microchip and an identification microdot;
a plurality of registration terminals operatively connected to the protection elements database, each of said registration terminals configured to retrieve one or more protection elements from the protection elements database and to register a selected asset by applying the one or more retrieved protection elements to one or more locations associated with the selected asset; and
a plurality of verification terminals accessible by authorized personnel and operatively connected to the assets database, said verification terminals configured to search the assets database for an input protection element.

5. The system of claim 4 wherein each verification terminal includes a protection element reader configured to read the input protection element.

6. The system of claim 4 wherein each registration terminal includes application equipment configured to apply the retrieved protection element to the one or more locations associated with the selected asset.
